(19) United States
(12) Patent Application Publication
(10) Pub. No.: US 2006/0102671 A1
(43) Pub. Date: May 18, 2006

(54) Multi tray cargo system

(75) Inventor: Robert C. Fitzpatrick, Holland, MI (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 10/537,860

(22) PCT Filed: Dec. 10, 2003
(86) PCT No.: PCT/US03/39388

§ 371 Date: Jun. 8, 2005

Related U.S. Application Data
(60) Provisional application No. 60/432,369, filed on Dec. 10, 2002.

(51) Int. Cl. B60R 7/00

(52) U.S. Cl. 224/543; 224/498

(57) ABSTRACT

A collapsible cargo system for a vehicle is disclosed. The collapsible cargo system comprises a flexible panel (18) and a plurality of generally parallel, spaced apart support members coupled to the panel (18) and configured to releasably couple the panel (18) to the vehicle. The at least one of the support members includes an interface portion (23) configured to selectively engage an interior component of the vehicle. The the panel (18) is deployable in a first use position wherein the support members are generally cross-car in the vehicle and the interface portion (23) is engaged with the interior component, and deployable in a stowed position.

### FIELD OF THE INVENTION

The present inventions relate to a system for storing cargo within a vehicle. The present inventions more specifically relate to a system for storing cargo that is configurable, reconfigurable, storable, and the like.

### BACKGROUND OF THE INVENTION

It is known to provide for cargo storage systems or organizers that may be used for storing or organizing cargo within a vehicle. Such known cargo storage systems, however, do not realize certain advantageous features (and/or combinations of features). For example, such known cargo storage systems are not reconfigurable in a variety of use (and non-use) positions and locations. Also, such known cargo systems are not capable of being stowed within the vehicle without reducing the usable space within the vehicle passenger compartment.

Accordingly, it would be advantageous to provide a multi tray cargo system. It would also be advantageous to provide a cargo system that is configurable, reconfigurable, stowable, and the like. It would be desirable to provide for a cargo system having one or more of these or other advantageous features. To provide an inexpensive, reliable, and widely adaptable cargo system that avoids the above-referenced and other problems would represent a significant advance in the art.

### SUMMARY OF THE INVENTION

The present invention relates to a collapsible cargo system for a vehicle comprising a flexible panel and a plurality of support members coupled to the panel and extending in a generally parallel direction. At least some of the support members being configured to releasably and/or selectively couple to the vehicle to provide a cargo storage arrangement.

The present invention also relates to a collapsible cargo system for a vehicle comprising a flexible panel and a plurality of support members coupled to the panel and extending in a generally parallel direction. At least some of the support members having interface portions configured to selectively engage apertures in an interior trim panel of the vehicle.

The present invention further relates to a collapsible cargo system for a vehicle comprising a flexible panel and a plurality of support members coupled to the panel and extending in a generally parallel direction. The collapsible cargo system being adapted to be in a use position wherein the support members are generally cross car in the vehicle and engaged with an interior surface of the vehicle, and adapted to be in a stowed position.

The present invention further relates to a collapsible cargo system for a vehicle. The cargo system comprises a flexible panel (18) and a plurality of generally parallel, spaced apart support members coupled to the panel (18) and configured to releasably couple the panel (18) to the vehicle. The at least one of the support members includes an interface portion (23) configured to selectively engage an interior component of the vehicle. The the panel (18) is deployable in a first use position wherein the support members are generally cross-car in the vehicle and the interface portion (23) is engaged with the interior component, and deployable in a stowed position.

The present invention further relates to various features and combinations of features shown and described in the disclosed embodiments.

### DESCRIPTION OF THE FIGURES

FIG. 1 is a fragmentary perspective view of a stowed cargo system according to a preferred embodiment.

FIG. 2 is a fragmentary perspective view of the stowed cargo system of FIG. 1.

FIG. 3 is a fragmentary perspective view of the cargo system of FIGS. 1 and 2 in a first use or deployed position.

FIG. 4 is a fragmentary perspective view of the cargo system of FIGS. 1 and 2 in a second (or alternative) use or deployed position.

FIG. 5 is a fragmentary perspective view of the cargo system of FIGS. 1 and 2 in a third (or alternative) use or deployed position.

FIG. 6 is a perspective view of a panel for the cargo system according to a preferred embodiment.

FIG. 7 is a side sectional view of the panel of FIG. 6 taken along the lines A-A.

FIG. 8 is a side sectional view of the panel of FIG. 6 taken along the lines B-B.

FIG. 9 is a fragmentary perspective view of the panel of FIG. 6 having a main batten (with an interface member) and a secondary batten according to a preferred embodiment.

FIG. 10 is a fragmentary top plan schematic view of the panel of FIG. 9.

FIG. 11 is a fragmentary perspective schematic view of the cargo area and the interface apertures according to a preferred embodiment.

FIG. 12 is a top plan view of an interface bezel or slot member according to a preferred embodiment.

FIG. 13 is a side sectional view of the interface bezel or slot member of FIG. 12 taken along line 13-13.

FIG. 14 is a fragmentary perspective view of the passenger and cargo compartment shown without the cargo panel and with the seats removed (or folded down).

FIG. 15 is a perspective view of a storage support or frame of FIG. 14 according to a preferred embodiment and shown in a stowed position.

FIG. 16 is a side view of the storage support or frame of FIG. 15 shown in a deployed position.

FIG. 17 is a perspective view of the panel rolled up and being stowed in a space defined by the trim panel.

### DETAILED DESCRIPTION OF PREFERRED AND OTHER EXEMPLARY EMBODIMENTS

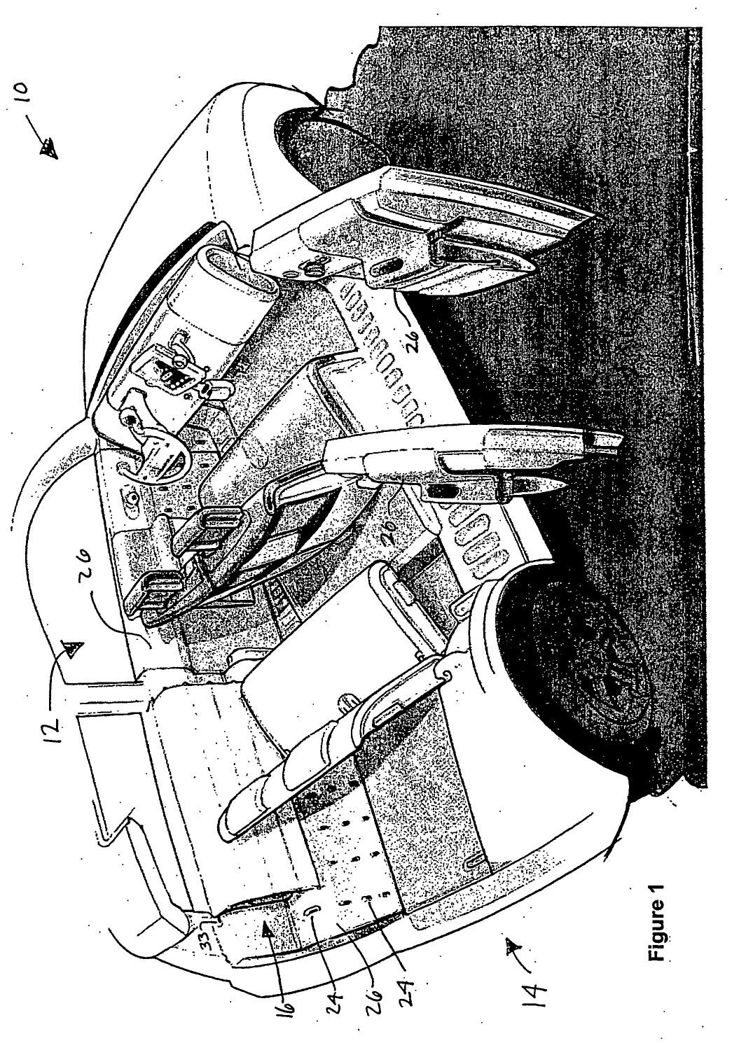

FIG. 1 is a fragmentary perspective view of a vehicle 10 including a passenger compartment 12 and a cargo area 14 with a cargo system 16 according to a preferred embodiment.

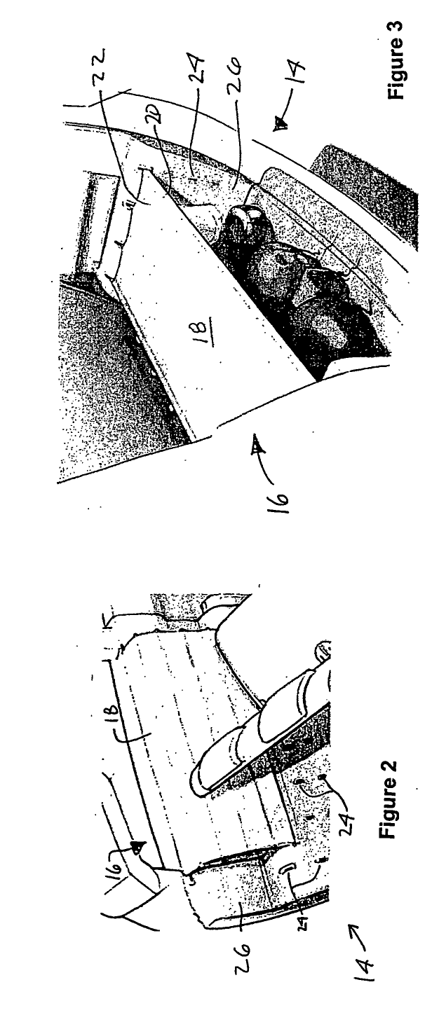

Cargo system 16 is movable (configurable, reconfigurable, etc.) between a use or deployed position (illustrated in FIGS. 1 and 2) and a stored or secondary or stowed position (illustrated in FIGS. 3, 4, and 5).

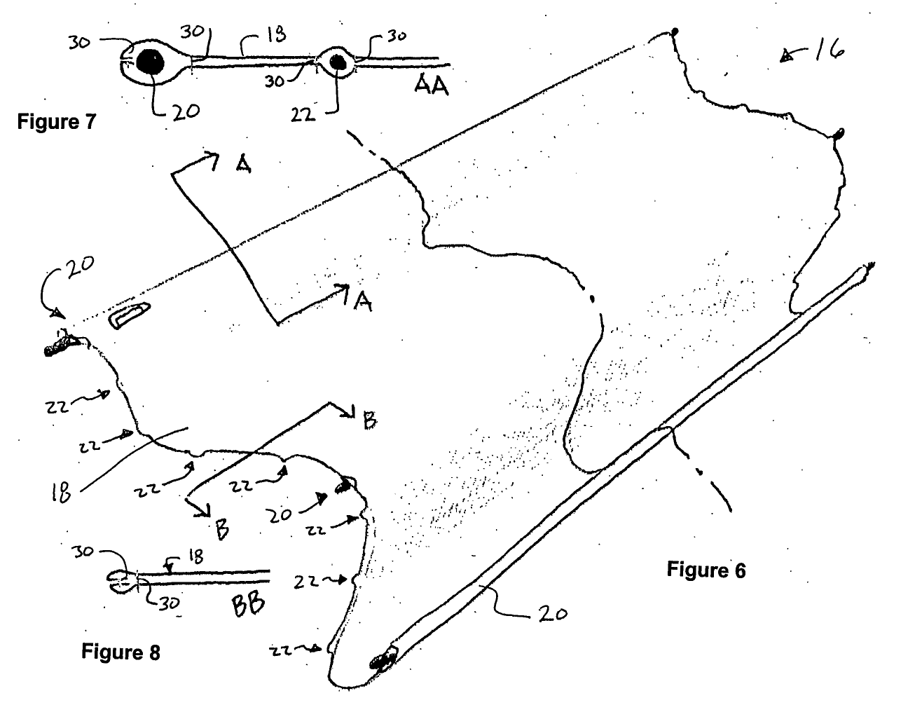

Cargo system 16 includes a panel 18, a plurality of structural members (shown as main battens 20 and support battens 22). According to an exemplary embodiment, the support structures are configured to be replaceable and/or removable (e.g., to facilitate washing panel 18). According to a preferred embodiment, panel 18 is formed from a flexible material (e.g., vinyl, cloth, fabric, leather, or the like). As such, cargo system 16 is configured to flex (e.g., bunch, roll up, be foldable, etc.) in one direction, and be rigid the other directions (e.g., perpendicular). Preferably, panel 18 is formed from the same material as the seats. Alternatively, panel 18 may be made from any number of decorative or durable materials (e.g., intended to take wear and tear, be washed, etc.), such as commercial grade seating fabric. Referring to FIGS. 6-10, panel 18 is preferably made from two sheets joined together (e.g., sewn, bonded, stapled, welded, fasteners, etc.) with main battens 20 and support battens 22 held in place (e.g., by seams 30, pleats, etc.). According to a particularly preferred embodiment, panel is made from a material commercially available from Xorel as XOREL fabric.

According to a preferred embodiment (shown in FIG. 6), cargo system 16 includes three main battens 20 and a pair of support battens 22 evenly spaced between each set of adjacent main battens 20. According to alternative embodiments, cargo system 16 may have any number of main battens 20 and support battens 22 spaced in any of a variety of configurations. According to a preferred embodiment, main battens 20 and support battens 22 are made from a flexible material (e.g., plastic, wood, metal, etc.). To deploy cargo system 16 in any of the use or deployed positions, main battens 20 are flexed or bent so that interface portions 23 (ends of main battens 20) may be aligned with apertures 24. As the main battens 20 are allowed to return to its unstressed state, interface portions 23 engage (e.g., slide, etc.) apertures 24.

Cargo system 16 couples to vehicle 10 at any combination of one or more interfaces. According to a preferred embodiment, interface portions 23 in main battens 20 engage apertures 24 (e.g., openings, holes, slots, grooves, recesses, etc.) in interior component (shown as trim panels 26). Alternatively, the cargo system may engage apertures on any of a variety of interior components (e.g., seats, consoles, doors, etc). Depending on the attachment to the interior component, panel 18 may be used as a security cover for the cargo area, or portions of the cargo area.

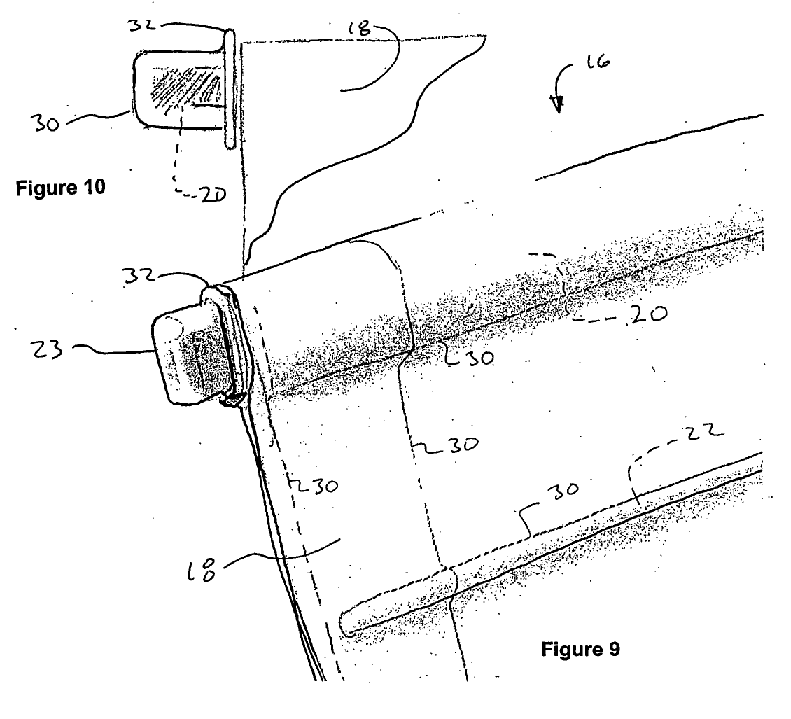

According to a preferred embodiment shown in FIG. 9, interface portion 23 includes a projection (shown as a shoulder 32) to inhibit sliding or removal of main battens 20 from panel 18. According to a particularly preferred embodiment, interface portion is a plastic molded part that is mounted to ends of main battens 20 (e.g., joining, bonding, fastener, interference fit, etc.). As shown in FIGS. 9 and 12, interface portion 23 and aperture 24 are preferably rectangular. Alternatively, any of a variety of shapes and configurations may be used (e.g., a hook for a more positive engagement, circular, etc.). Also, support battens 22 are preferably captured between the sheets of panel 18 by seam 30.

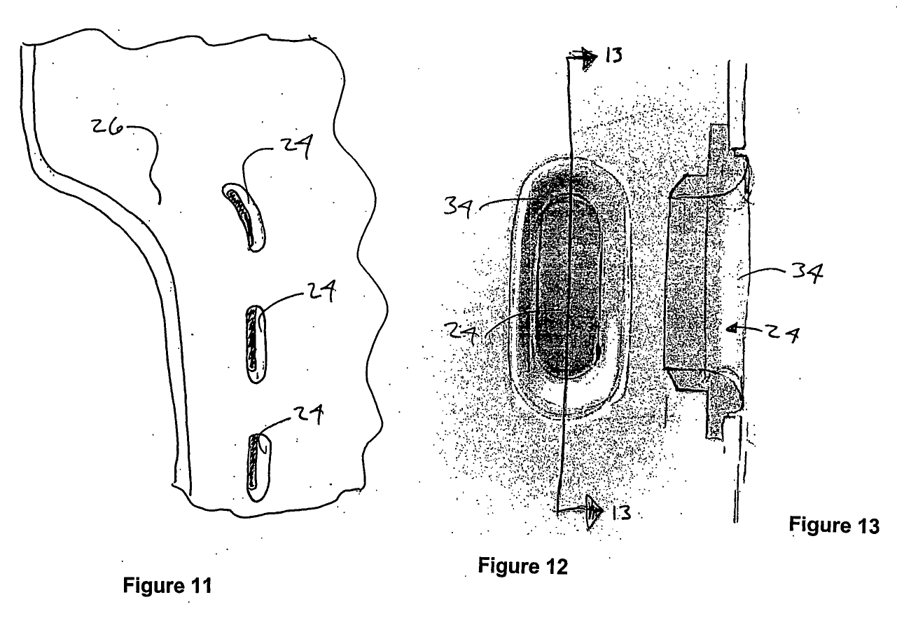

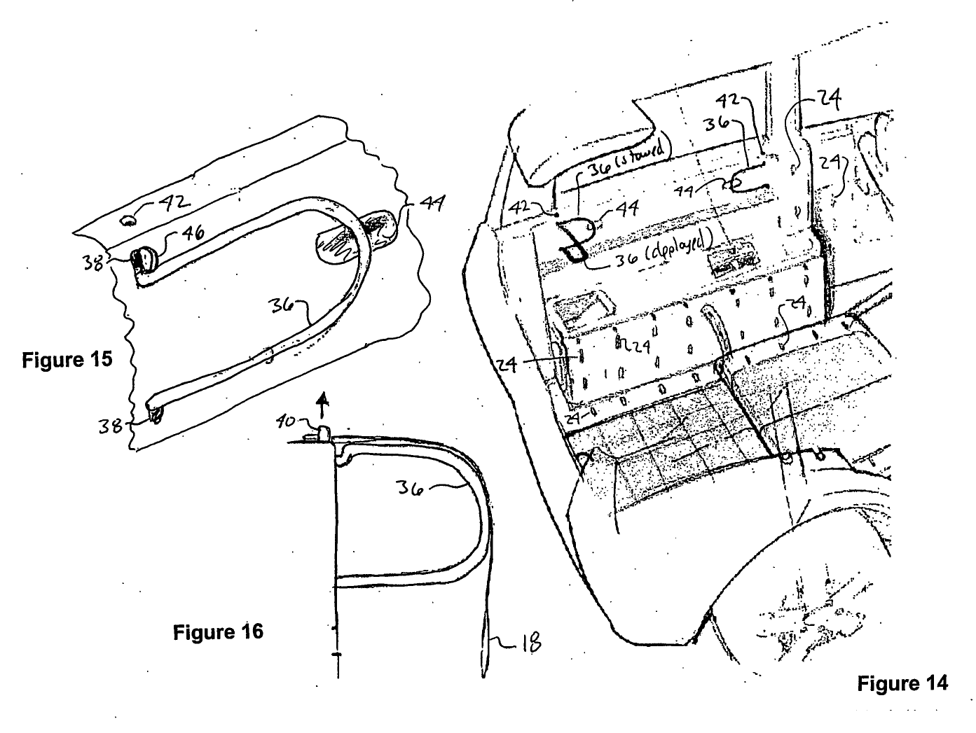

Referring to FIGS. 11 and 14, apertures 24 are located at a variety of locations along interior trim panels 26 (e.g., spaced apart height levels and fore-aft locations). As such, cargo system 16 may be arranged and configured (or reconfigured) in any number of positions. According to a preferred embodiment, aperture 24 is provided or defined by a bezel or slot member 34 mounted in openings in trim panel 26. Slot members 34 are coupled to trim panel 26 by any of a variety of methods (e.g., bonding, press-fit, adhesive, welding, fasteners, etc.).

Cargo system 16 is configured to be multi-functional in use. For example, FIG. 3 is a fragmentary perspective view of the cargo system of FIGS. 1 and 2 in a first use or deployed position. In this position, cargo system 16 acts as a shelf so that additional items may be placed on it (i.e., provides a first or upper cargo space and a second or lower cargo space). Also, cargo system 16 acts as a security cover to obscure visual access to a portion of the cargo area 14.

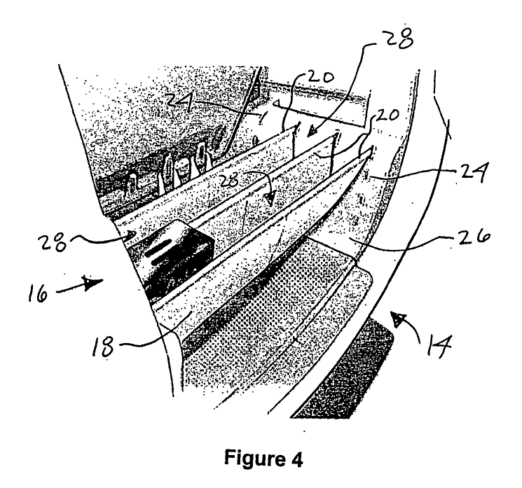

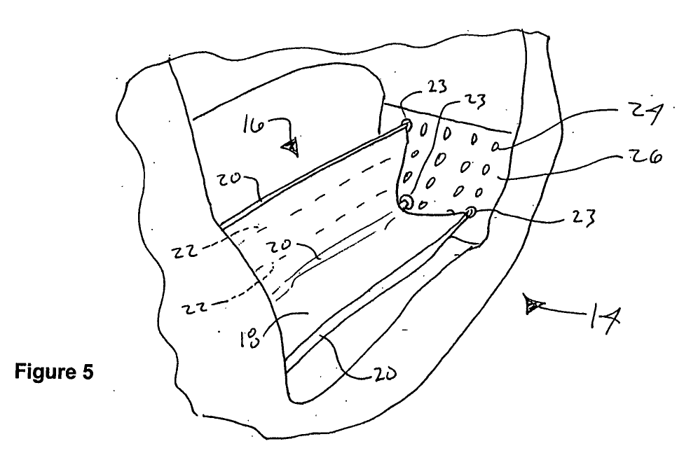

According to an alternative embodiment shown in FIG. 4, cargo system 16 is arranged to provide a plurality of cargo slots 28 (e.g., spaces, receptacles, etc.). The three main battens 20 are coupled along a top portion of interior trim panel 26 so that panel 18 hangs (e.g., droops, sags, etc.) down to form the cargo slots 28. Interface portions 23 of main battens 20 may also engage other apertures 24 to provide different sizes and orientations of cargo slots 28 (e.g., rather than engaging adjacent and sequential apertures 24, main battens may engage apertures 24 at different heights, longitudinal spacing, etc.). Alternatively, as shown in FIG. 5, cargo system 16 is arranged to provide a plurality of cargo spaces (e.g., slots, receptacles, etc.). In yet another alternative embodiment, cargo system 16 is arranged to provide another configuration for stowing cargo.

To use or deploy cargo system 16 in any of the use or deployed positions, main battens 20 are flexed or bent so that interface portions 23 (ends of main battens 20) may be aligned with apertures 24. As the main battens 20 are allowed to return to its unstressed state, interface portions 23 engage (e.g., slide, etc.) apertures 24.

Referring again to FIG. 2, to store or stow cargo system 16, main battens 20 are flexed or bent so that interface portions 23 may be removed from engagement with apertures 24 (interior trim panels 26). According to an exemplary embodiment, interior trim panels 26 include a slot 33 configured to receive one or more interface portions 23. As such, panel 18 may be hung from, for example, an upper portion of interior trim panel 26 by a main batten 20 disposed along an outer edge of cargo system 16, or between edges of cargo system 16 (e.g., folded in have so that the middle main batten 20 may be used to hang cargo system 16), or the like. According to other alternative embodiments, cargo system 16 may be rolled up, folded, bunched, or the like and place at any of a variety of locations in vehicle 10, passenger compartment 12, or cargo area 14.

According to an exemplary embodiment shown in FIGS. 14-16, a storage support or frame 36 is used to store or stow cargo system 16, and/or to provide additional configurations for arranging cargo system 16. FIG. 14 shows frame 36 in a stowed position. In the stowed position, frame 36 preferably is located in a groove or recess in trim panel 26 so as to not extend beyond (or extend minimally) the surface of trim panel 26. FIG. 16 shows frame 36 in a deployed position. According to a preferred embodiment, ends of frame 36 engage openings 38 in trim panel 26, and orientated so that when frame 36 is pivoted into the deployed position, one of its end 40 (e.g., post, nub, detent, etc.) becomes aligned with and engages an aperture 42 in trim panel 26. A biasing force generated by frame 36 generally being in tension (i.e., compression), such that ends of frame 36 are biased away from each other. To move frame 36 from the stowed position to the deployed position, the user grips frame 36 by looping one or more fingers around frame 36 at a recess 44, and rotates frame to a position generally perpendicular to trim panel 26. End 40 slides along an interior surface of trim panel 26 until end 40 is aligned or registered with aperture 42. The biasing force in frame 36 forces end 40 through aperture 42 (e.g., pops or snap fit). Frame 36 bears against a projection 46. Slot is located adjacent projection 46 is orientated to guide frame 36 generally upward as end 40 engages aperture 42. According to an alternative embodiment, frame 36 is coupled to trim panel 26 by a pair of hinges.

In the deployed position, panel 18 may wrap around frame 36 and couple to end of frame 36 or to interior trim panel 26. As such, another storage space is formed by frame and panel 18. Alternatively, panel 18 may be allowed to hang from frame 36 (e.g., free or couple below). Also, when not being used (deployed), cargo system 16 may be rolled up, folded, or the like and place beneath seats, in cargo storage areas or bins, in cargo area 14, or the like.

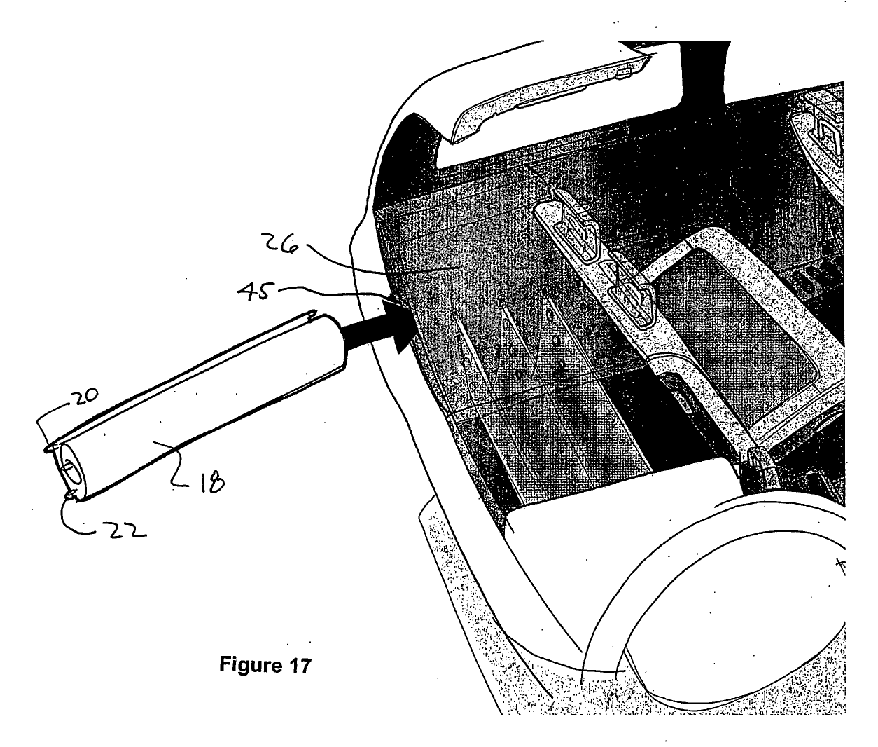

FIG. 17 is a perspective view of the panel rolled up and being stowed in a space 45 (e.g., cavity, storage space, etc.) defined by the trim panel. According to alternative embodiments, panel 18 may be folded for stowing. Also, the space for stowing or storing panel 18 may be at any of a variety of locations in or on the vehicle. Use of a space in the cargo area is shown for example only.

It is also important to note that the construction and arrangement of the elements of the cargo system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, the panel may be used as a security cover for the cargo area, or portions of the cargo area. Also, elements shown as integrally formed may be constructed of multiple parts or elements show as multiple parts may be integrally formed, the operation of the interfaces (e.g. clamps, etc.) may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). It should be noted that the elements and/or assemblies of the system may be constructed from any of a wide variety of materials that provide sufficient strength or durability, in any of a wide variety of colors, textures and combinations. It should also be noted that the cargo system may be used in association with a variety of vehicles (e.g., sedans, SUVs, vans, minivans, trucks, boats, or alternatively other, cargo areas or any of a wide variety of other applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

1. A collapsible cargo system for a vehicle comprising:
a flexible panel;
at least one trim panel coupled to the vehicle;
a plurality of generally parallel, spaced apart support members coupled to the panel and configured to releasably couple the panel to the at least one trim panel;
wherein at least one of the support members includes an interface portion (23) configured to selectively engage apertures on the at least one trim panel;
wherein the panel is deployable in a plurality of use positions wherein the support members are generally cross-car in the vehicle and the interface portion is engaged with one of the apertures on the at least one trim panel, and deployable in a stowed position.

2. The cargo system of claim 1 wherein the support members comprise two or more main battens and at least one support batten, wherein the main battens have the interface portions.

3. The cargo system of claim 2 wherein each aperture is a slot defined by a bezel.

4. The cargo system of claim 1 wherein the plurality of use positions comprise a first use position, a second use position and a third use position wherein the support members are generally cross-car in the vehicle and the interface portion is engaged with the at least one trim panel, and deployable in a stowed position.

5. The cargo system of claim 2 wherein the main battens engage the at least one trim panel by bending of the main battens, aligning the interface portion with the aperture, and releasing the main batten to its relaxed state.

6. The cargo system of claim 2 wherein the panel is collapsible for storage when in the stowed position.

7. The cargo system of claim 1 further comprising a frame rotatably coupled to the at least one trim panel.

8. The cargo system of claim 7 wherein the frame is coupled to the at least one trim panel by engagement of a detent on the frame and apertures on the at least one trim panel, wherein the frame is biased so that the detent engages apertures in the at least one trim panel.

9. A collapsible cargo system for a vehicle comprising:
a flexible panel;
a plurality of generally parallel, spaced apart support members coupled to the panel and configured to releasably couple the panel to the vehicle; and
a frame rotatably coupled to an interior component;
wherein at least one of the support members includes an interface portion configured to selectively engage the interior component of the vehicle;
wherein the panel is deployable in a first use position wherein the support members are generally cross-car in the vehicle and the interface portion is engaged with the interior component, and deployable in a stowed position; and
wherein the frame is coupled to the interior component by engagement of a detent on the frame and apertures on the frame, wherein the frame is biased so that the detent engages apertures in the interior component.

10. A collapsible cargo system for a vehicle comprising:
a flexible panel;
a plurality of generally parallel, spaced apart support members coupled to the panel and configured to releasably couple the panel to the vehicle;
wherein at least one of the support members includes an interface portion configured to selectively engage an interior component of the vehicle;
wherein the panel is deployable in a first use position wherein the support members are generally cross-car in the vehicle and the interface portion is engaged with the interior component, and deployable in a stowed position;
wherein the support members comprise two or more main battens and at least one support batten, wherein the main battens (have the interface portions; and
wherein the main battens engage the interior component by bending of the main battens, aligning the interface portion with an aperture on the interior component, and releasing the main batten to its relaxed state.

11. The cargo system of claim 9 wherein the support members comprise two or more main battens and at least one support batten, wherein the main battens have the interface portions.

12. The cargo system of claim 11 wherein each aperture is a slot defined by a bezel.

13. The cargo system of claim 10 further comprising a frame rotatably coupled to the at least one trim panel.

14. The cargo system of claim 13 wherein the frame is coupled to the at least one trim panel by engagement of a detent on the frame and apertures on the at least one trim panel, wherein the frame is biased so that the detent engages apertures in the at least one trim panel.
